(19) United States
(12) Patent Application Publication
(10) Pub. No.: US 2011/0241554 A1
(43) Pub. Date: Oct. 6, 2011

(54) ELECTRONIC BOOK

(75) Inventors: BIN GONG, Shenzhen City (CN); MING-CHANG LEE, Tu-Cheng (TW)

(73) Assignees: HONG FU JIN PRECISION INDUSTRY (ShenZhen) CO., LTD., ShenZhen City (CN); HON HAI PRECISION INDUSTRY CO., LTD., Tu-Cheng (TW)

(21) Appl. No.: 12/784,515

(22) Filed: May 21, 2010

(30) Foreign Application Priority Data
Mar. 30, 2010 (CN) 201010136111.7

(51) Int. Cl. H05B 37/02; F21V 33/00

(52) U.S. Cl. 315/159; 362/253

(57) ABSTRACT

An electronic book includes a shell, a main body including an electro-phoretic display and mounted to the shell, and a lighting body mounted to the shell. When the electronic book is used in darkness, the lighting body lights the main body.

### BACKGROUND

1. Technical Field

The present disclosure relates to an electronic book.

2. Description of Related Art

Due to small size, light weight and ease of storage, electronic books are widely used. A conventional electronic book includes an electro-phoretic display (EPD). However, the electro-phoretic display is only visible when being externally lit.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic view of an exemplary embodiment of an electronic book.

FIG. 2 is a use state of the electronic book of FIG. 1, the electronic book including a lighting body.

FIG. 3 is a block diagram of the lighting body of FIG. 1.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

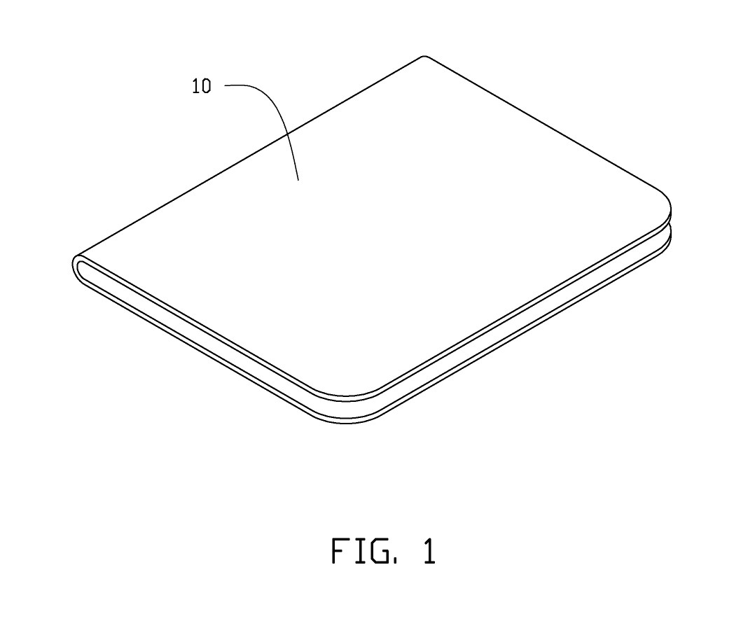

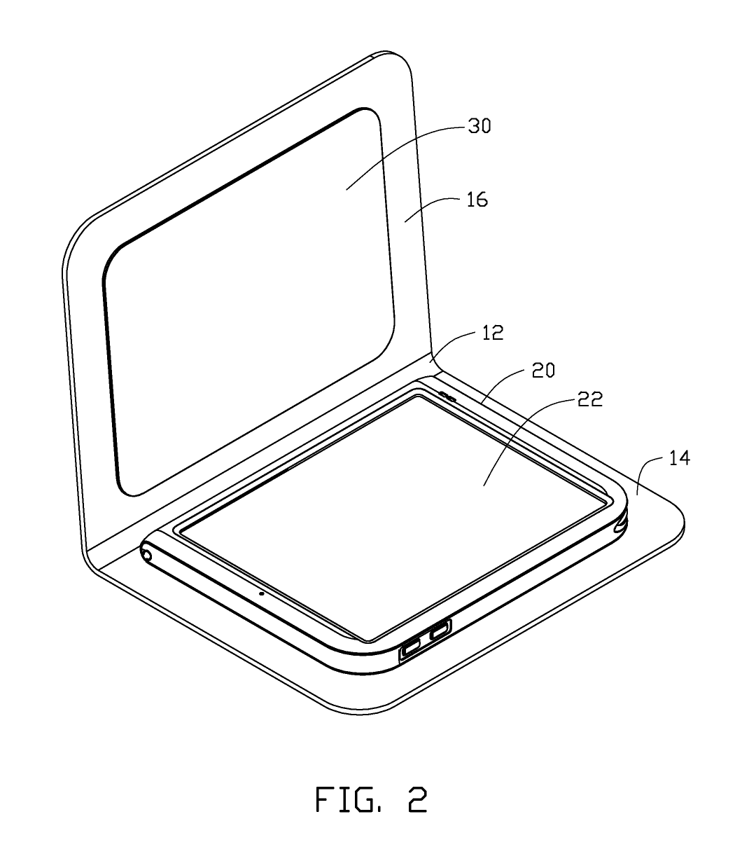

Referring to FIGS. 1 and 2, an exemplary embodiment of an electronic book includes a protecting shell 10, a main body 20, and a lighting body 30. The protecting shell 10 includes an arc-shaped first protecting plate 12, a second protecting plate 14 and a third protecting plate 16 pivotably mounted to two opposite sides of the first protecting plate 12, respectively. The main body 20 is mounted to the second protecting plate 14 and the lighting body 30 is mounted to the third protecting plate 16.

The main body 20 is as an electronic book and includes an electro-phoretic display (EPD) 22.

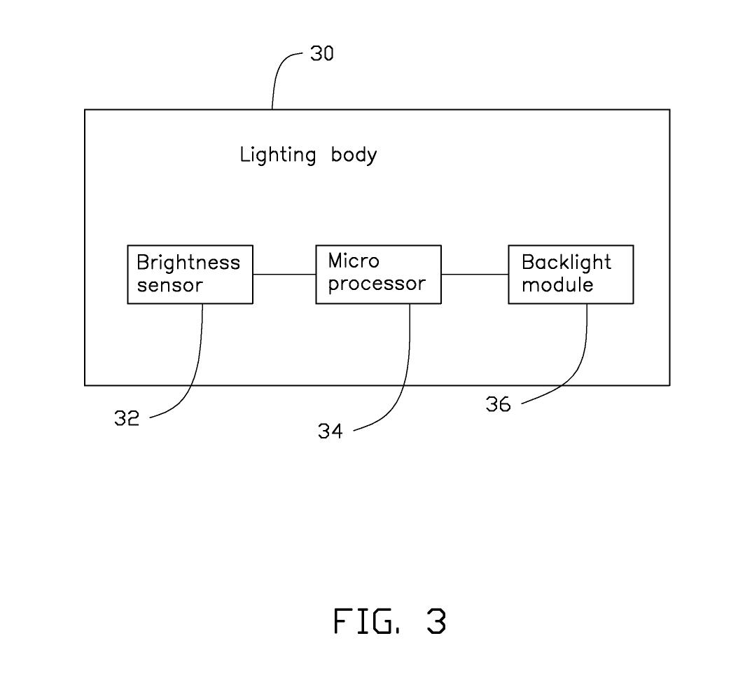

Referring to FIG. 3, the lighting body 30 includes a brightness sensor 32, a micro processor 34, and a backlight module 36. The micro processor 34 stores a first brightness datum and a second brightness datum, and is electrically connected to the brightness senor 32 and the backlight module 36. The second brightness datum is greater than the first brightness datum.

In use, the brightness sensor 32 measures available ambient light around the electronic book and sends the result to the micro processor 34. The micro processor 34 receives the measured brightness and compares it with the first brightness datum and the second brightness datum. When the measured brightness is less than the first brightness datum, the micro processor 34 outputs a first controlling signal to turn on the backlight module 36. When the brightness datum is greater than the second brightness datum, the micro processor 34 outputs a second controlling signal to turn off the backlight module 36.

In other embodiments, the lighting body 30 includes a backlight module and a switch. In darkness, a user can operate the switch to control the backlight module.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An electronic book comprising:
a shell;
a main body comprising an electro-phoretic display and mounted to the shell; and
a lighting body mounted to the shell;
wherein when the electronic book is used in a darkness, the lighting body lights the main body.

2. The electronic book of claim 1, wherein the lighting body comprises a brightness sensor, a micro processor, and a backlight module, the brightness sensor measures available light around the electronic book and sends the result to the micro processor, the micro processor selectionally outputs a first controlling signal or a second controlling signal to turn on or turn off the backlight module.

3. The electronic book of claim 1, wherein the shell comprises a first protecting plate, a second protecting plate and a third protecting plate pivotably mounted to two opposite sides of the first protecting plate respectively, the main body is mounted to second protecting plate, the lighting body is mounted to the third protecting plate.
